(19) United States
(12) Patent Application Publication
(10) Pub. No.: US 2015/0153987 A1
(43) Pub. Date: Jun. 4, 2015

(54) IMAGE FORMING SYSTEM, IMAGE FORMING METHOD, AND CONTROL PROGRAM

(71) Applicant: KYOCERA Document Solutions Inc., Osaka (JP)

(72) Inventor: Yoshiyuki Taira, Osaka (JP)

(21) Appl. No.: 14/554,082

(22) Filed: Nov. 26, 2014

(30) Foreign Application Priority Data
Nov. 29, 2013 (JP) 2013-247961

(51) Int. Cl. G06F 3/12

(52) U.S. Cl. CPC G06F 3/1267; G06F 3/1288; G06F 3/1226; G06F 3/1236

(57) ABSTRACT

An image forming system includes an image forming apparatus enabling pull printing and a terminal. The terminal includes a pull-printing server, a search unit, and a port setting unit. The pull-printing server accumulates print data for pull printing. The search unit searches for the pull-printing server and the image forming apparatus. The port setting unit sets different ports for the pull-printing server and the image forming apparatus that have been detected by the search unit. The image forming apparatus includes a pull-print data acquisition unit. The pull-print data acquisition unit acquires print data from the terminal through the port of the pull-printing server set by the port setting unit of the terminal.

### INCORPORATION BY REFERENCE

The disclosure of Japanese Patent Application No. 2013-247961 filed on Nov. 29, 2013 including the specification, drawings and abstract is incorporated herein by reference in its entirety.

### BACKGROUND

This disclosure relates to image forming systems, image forming methods, and control programs, and more particularly to an image forming system, an image forming method, and a control program, enabling pull printing that allows print data to be temporarily accumulated and to be output in response to an instruction from an image forming apparatus.

Conventionally, there have been image forming apparatuses, such as multifunctional peripherals (MFP), capable of printing text and graphical images.

Some of the image forming apparatuses support a “pull printing” feature that allows an image forming apparatus to temporarily accumulate print data acquired from a terminal in a built-in HDD thereof, an external server, or the like and to output the print data in response to an instruction input by a user through the image forming apparatus.

Such image forming apparatus with the pull printing feature has been conventionally developed.

In addition, there have been systems that install programs implementing a pull-printing server feature into a terminal, accumulate print data in the terminal, and cause an image forming apparatus to perform pull printing.

By the way, programs called “universal printer driver” have been conventionally known. The universal printer driver executed on a terminal can search a plurality of image forming apparatuses on a network for an image forming apparatus and install a device driver appropriate to the model of the detected image forming apparatus.

### SUMMARY

In an aspect of the present disclosure, an image forming system includes an image forming apparatus enabling pull printing and a terminal The terminal includes a pull-printing server, a search unit, and a port setting unit. The pull-printing server accumulates print data for pull printing. The search unit searches for the pull-printing server and the image forming apparatus. The port setting unit sets different ports for the pull-printing server and the image forming apparatus that have been detected by the search unit. The image forming apparatus includes a pull-print data acquisition unit. The pull-print data acquisition unit acquires print data from the terminal through the port of the pull-printing server set by the port setting unit of the terminal.

In another aspect of the present disclosure, an image forming method is implemented by an image forming system including an image forming apparatus enabling pull printing and a terminal. The image forming method includes searching for a pull-printing server and the image forming apparatus, setting different ports for the detected pull-printing server and the image forming apparatus, accumulating print data for pull printing in the pull-printing server, and acquiring the print data from the terminal through the set port of the pull-printing server.

In yet another aspect of the present disclosure, a control program is executed by a terminal in an image forming system that includes an image forming apparatus enabling pull printing and a terminal. The control program causes the terminal to search for a pull-printing server and the image forming apparatus, to set different ports for the detected pull-printing server and image forming apparatus, and to accumulate print data for pull printing in the pull-printing server.

### BRIEF DESCRIPTION OF THE DRAWINGS

FIG. 1 illustrates the system configuration of an image forming system according to an embodiment of the present disclosure.

FIG. 2 is a flow chart of pull print setting/printing processing according to the embodiment of the disclosure.

FIG. 3 illustrates a pull print function screen as shown by an exemplary screen.

FIG. 4 is a block diagram of the entire configuration of the image forming system shown in FIG. 1.

FIG. 5 is a schematic view of the image forming apparatus shown in FIG. 1.

### DETAILED DESCRIPTION

### Embodiment

[Entire Configuration of Image forming System X]

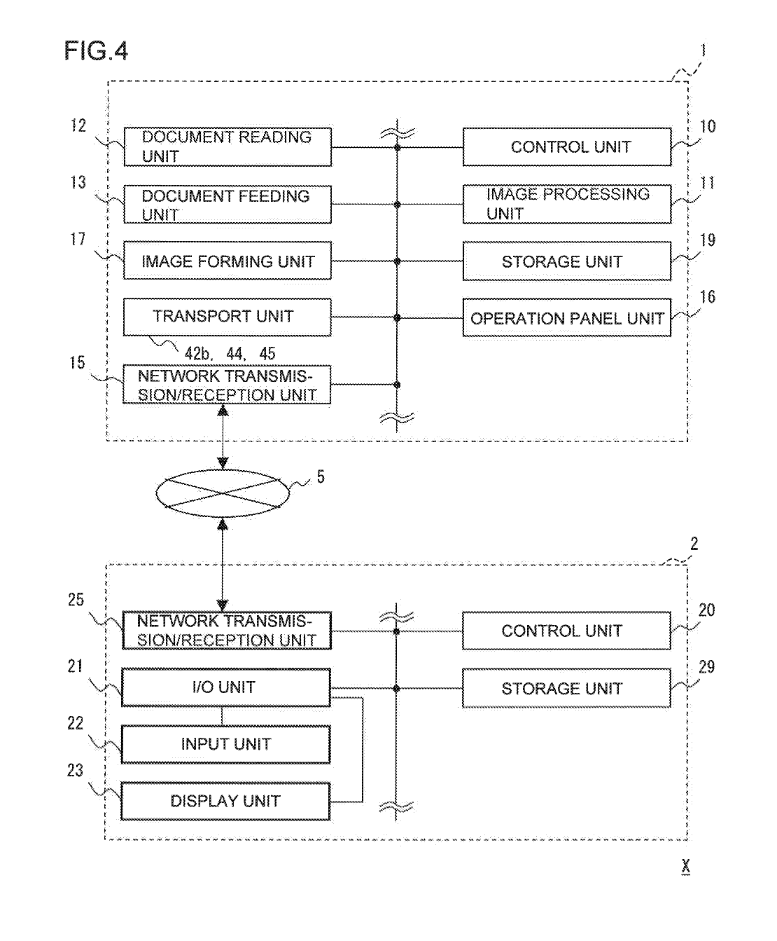

Referring to FIG. 4, descriptions will be given about the entire configuration of an image forming system X according to an embodiment of the present disclosure.

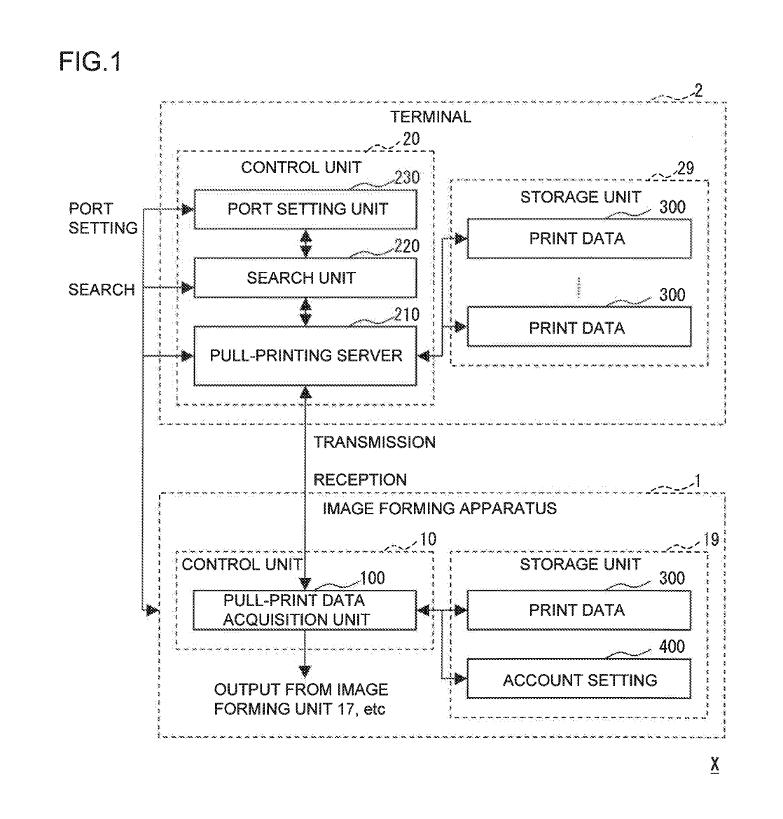

The image forming system X includes an image forming apparatus 1 capable of pull printing and a terminal 2 accumulating print data 300 (FIG. 1) for pull printing.

The image forming apparatus 1 is an image forming apparatus, such as an MFP, capable of acquiring print data 300 from the terminal 2 to perform pull printing.

The terminal 2 is a terminal of some kind, including a personal computer (PC), such as a PC/AT compatible computer, a cell phone, a smart phone, a tablet terminal, etc.

The image forming apparatus 1 and the terminal 2 are connected to each other via a network 5, such as a LAN, a wireless LAN, a WAN, and a cellular network.

### (Entire Configuration of Image Forming Apparatus 1)

The image forming apparatus 1 includes a control unit 10 connected to an image processing unit 11, a document reading unit 12, a document feeding unit 13, a transport unit (paper feeding rollers 42b, a pair of paper transport rollers 44, a pair of paper ejection rollers 45), a network transmission/reception unit 15, an operation panel unit 16, an image forming unit 17, a storage unit 19 and some other units. The control unit 10 controls the operation of each of those units.

The control unit 10 is an information processing unit, such as a general purpose processor (GPP), a central processing unit (CPU), a micro processing unit (MPU), a digital signal processor (DSP), a graphics processing unit (GPU), and an application-specific integrated circuit (ASIC).

The control unit 10 acts as various units in functional blocks, which will be described later, by reading a control program stored in a ROM or a HDD of the storage unit 19 and developing the control program in a RAM to execute it. In addition, the control unit 10 controls the entire image forming apparatus in response to predetermined instruction information input from external terminals (not shown) or through the operation panel unit 16.

The image processing unit 11 is a control arithmetic unit, such as a digital signal processor (DSP) and a graphics processing unit (GPU). The image processing unit 11 performs predetermined image processing on image data, for example, scaling, intensity adjustment, tone adjustment, and image enhancement.

The image processing unit 11 also can store images read by the document reading unit 12 in the storage unit 19 as print data 300. Before storing the print data 300 in the storage unit 19, the image processing unit 11 can convert the print data 300 into a file unit of PDF, TIFF or other format types. The converted print data 300 can be transmitted to the terminal 2.

The document reading unit 12 reads (scans) documents set thereon.

The document feeding unit 13 transports the documents to be read by the document reading unit 12.

The image forming unit 17 forms an image of data on a sheet of recording paper in response to an output instruction by a user. The data may be stored in the storage unit 19, read by the document reading unit 12, or acquired from external terminals.

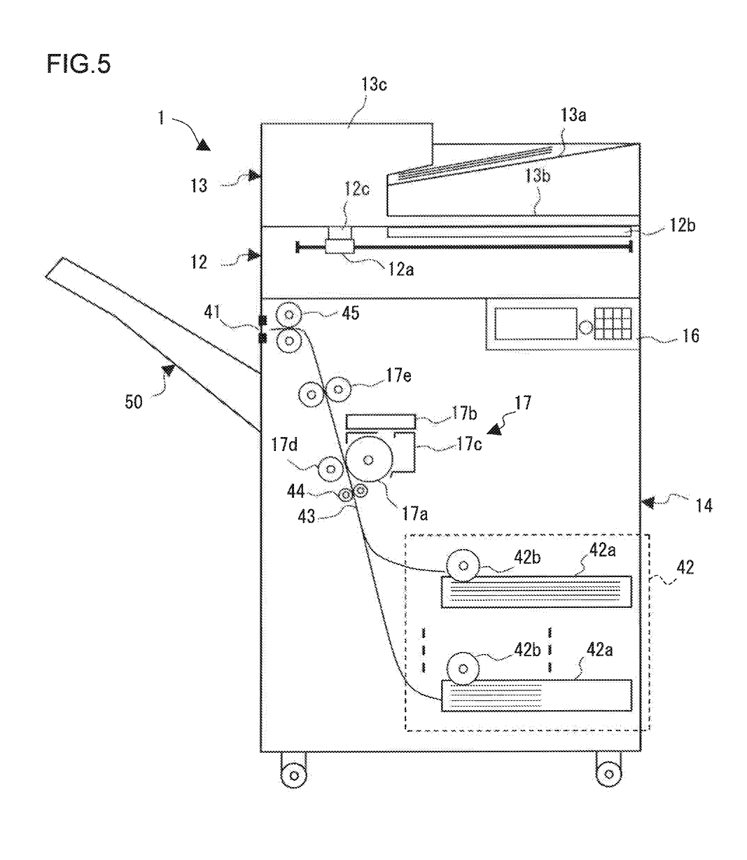

The transport unit takes out recording paper from paper cassettes 42a (FIG. 5), carries the paper to the image forming unit 17 to form images, and subsequently ejects the paper out to a stack tray 50.

The operations of the document reading unit 12, document feeding unit 13, transport unit, and image forming unit 17 will be described later.

The network transmission/reception unit 15 is a network connection unit and may be a LAN board, wireless transceiver, or other components used to connect to a LAN, a wireless LAN, a WAN, and an external network, such as a cellular network.

The network transmission/reception unit 15 transmits and receives data through a data communication line and voice signals through a voice telephone line.

The operation panel unit 16 is provided with a display unit, such as an LCD, and an input unit. The input unit includes a numeric keypad, a start button, a cancellation button, mode switch buttons for changing operating modes among copying, FAX transmission, scanning and so on, buttons or a touch panel for providing instructions to execute jobs including printing, transmission, saving, and recording of selected documents.

Through the operation panel unit 16, the image forming apparatus 1 acquires various job instructions from users. In addition, individual user's information can be input or changed in response to the user's instruction acquired through the operation panel unit 16.

The storage unit 19 is a storage unit using semiconductor memory such as a read only memory (ROM) and a random access memory (RAM), flash memory disk such as a solid state drive (SSD), and recording media such as a hard disk drive (HDD).

The ROM and HDD of the storage unit 19 contain control programs to control the operation of the image forming apparatus 1. In addition to the control programs, the storage unit 19 stores user account setting 400 (FIG. 1). The storage unit 19 also can have a region for document boxes each storing print data 300, each of the document boxes being prepared for a different user.

In the image forming apparatus 1, the control unit 10 and image processing unit 11 can be formed into an integral unit like a CPU/GPU integration and a chip-on-module package.

The control unit 10 and image processing unit 11 can have a RAM, a ROM, a flash memory or the like embedded therein.

The image forming apparatus 1 can also include a FAX transmission/reception unit to perform facsimile transmission and reception.

### (Entire Configuration of Terminal 2)

The terminal 2 includes a control unit 20, an I/O unit 21, an input unit 22, a display unit 23, a network transmission/reception unit 25, and a storage unit (print data accumulation unit) 29. The control unit 20 controls the operation of each of those units.

The control unit 20 is a control unit having computing/control capabilities, such as a CPU, an MPU, a DSP, a GPU, and an ASIC. The control unit 20 executes various programs stored in the storage unit 29 with hardware resources.

The I/O unit 21 is a component unit providing an interface, such as a DVI, an analog RGB, an HDMI (trademark), a USB, an IEEE 1394, a serial interface, a parallel interface, an infrared interface, and a wireless interface, to connect to various peripheral devices. The I/O unit 21 is connected to the input unit 22 and display unit 23.

The input unit 22 is an input unit, such as a keyboard, a mouse, a touch panel, and a touch pad, used to input various types of setting information, user authentication information and so on.

The display unit 23 is an LCD display, an organic electroluminescent display, or the like. The display unit 23 can display various setting screens of the operating system (OS), work screens of application software, and other types of screens.

The network transmission/reception unit 25 is, for example, a LAN interface or a wireless LAN interface compliant with 1000 BASE-T/100 BASE-TX, or a cell-phone radio wave transmission/reception device, to connect to the network 5. The terminal 2 can transmit and receive print data 300 (FIG. 1), user IDs and passwords required at the time of user login, and so on, through the network transmission/reception unit 25.

Alternatively, the network transmission/reception unit 25 can be connected to the network 5 through an external hub, an external router, or the like.

The storage unit 29 includes a main storage unit such as a RAM, a flash memory disk such as a SSD, and an auxiliary storage unit such as a HDD, a magnetic tape drive, and an optical disc drive.

The storage unit 29 stores various programs and data, the programs including a control program that causes the terminal 2 to function as a terminal for making documents and supporting pull printing. To achieve those functions, the storage unit 29 stores an operating system (OS) provided with a graphical user interface (GUI), application software such as word processing software, spreadsheet software, drawing software, a WWW browser, and an electronic mailer, control programs such as a device driver of the image forming apparatus 1, and other types of programs and data. The programs and data can be retrieved for execution and rewritten by the control unit 20.

The storage unit 29 can temporarily store the print data 300 (FIG. 1) in which the control unit 20 created with the application software and output through a device driver, in a pull-printing server 210 such as a spooling server. The accumulated print data 300 is transmitted when the image forming apparatus 1 issues an instruction to perform pull printing.

### [Operation of Image Forming Apparatus 1]

Referring to FIG. 5, descriptions will be given about the operation of the image forming apparatus 1 according to the embodiment of the present disclosure.

The document reading unit 12 is disposed on the upper part of a main body 14, and the document feeding unit 13 is disposed over the document reading unit 12. The stack tray 50 is disposed on the same side as a recording paper ejection opening 41 formed in the main body 14, and the operation panel unit 16 is disposed on the front side of the image forming apparatus 1.

The document reading unit 12 includes a scanner 12a, a platen glass 12b, and a document reading slit 12c. The scanner 12a includes an exposure lamp, a charge coupled device (CCD), a complementary metal oxide semiconductor (CMOS) image sensor, and some other components, and is configured to be movable along the direction in which documents are transferred by the document feeding unit 13.

The platen glass 12b is a document table made of a transparent member, such as glass. The document reading slit 12c has a slit formed perpendicular to the direction in which documents are transferred by the document feeding unit 13.

When reading a document placed on the platen glass 12b, the scanner 12a is moved to a position facing the platen glass 12b, scans and reads the document on the platen glass 12b to acquire image data of the document, and then outputs the acquired image data to the control unit 10 (FIG. 4) disposed in the main body 14.

When reading a document fed by the document feeding unit 13, the scanner 12a is moved to a position facing the document reading slit 12c, reads the document through the document reading slit 12c in synchronization with the document feeding operation performed by the document feeding unit 13 to acquire image data of the document, and outputs the acquired image data to the control unit 10 disposed in the main body 14.

The document feeding unit 13 includes a document placement unit 13a, a document ejection unit 13b, and a document transport mechanism 13c. Documents placed on the document placement unit 13a are delivered one by one sequentially by the document transport mechanism 13c, transported to a position facing the document reading slit 12c, and then ejected to the document ejection unit 13b.

The document feeding unit 13 is a fold-down type unit and can be lifted upward to clear the upper surface of the platen glass 12b.

The main body 14 includes, in addition to the image forming unit 17, a paper feeding unit 42, a paper transport path 43, a pair of paper transport rollers 44, and a pair of paper ejection rollers 45. The paper feeding unit 42 includes a plurality of paper cassettes 42a each accommodating recording paper different in size and orientation, and paper feeding rollers 42b delivering the recording paper one by one from the paper cassettes 42a to send it out to the paper transport path 43. The paper feeding rollers 42b, pair of paper transport rollers 44, and pair of paper ejection rollers 45 also function as a transport unit. The recording paper is transported by the transport unit.

The recording paper taken out by the paper feeding rollers 42b to the paper transport path 43 is transported by the pair of paper transport rollers 44 to the image forming unit 17. Then, the recording paper undergoes image recording operation by the image forming unit 17 and is ejected by the pair of paper ejection rollers 45 to the stack tray 50.

The image forming unit 17 includes a photoconductive drum 17a, an exposure unit 17b, a developing unit 17c, a transfer unit 17d, and a fixing unit 17e. The exposure unit 17b is an optical unit provided with a laser device, mirrors, lenses, LED arrays and other optical components, and outputs a kind of light based on image data, exposes the primarily charged photoconductive drum 17a to the light, and forms an electrostatic latent image on the surface of the photoconductive drum 17a. The developing unit 17c is used to develop the electrostatic latent image formed on the photoconductive drum 17a with toner, and forms a toner image corresponding to the electrostatic latent image on the photoconductive drum 17a. The transfer unit 17d transfers the toner image formed on the photoconductive drum 17a by the developing unit 17c to recording paper. The fixing unit 17e applies heat to the recording paper with the toner image transferred thereon by the transfer unit 17d to fix the toner image on the recording paper.

[Configuration of Image forming System X]

With reference to FIG. 1, detailed configuration of the image forming system X will be described.

The control unit 10 of the image forming apparatus 1 includes a pull-print data acquisition unit 100. The storage unit 19 stores print data 300 and account setting 400.

The control unit 20 of the terminal 2 includes a pull-printing server 210, a search unit 220, and a port setting unit 230. The storage unit 29 stores and accumulates print data 300.

The pull-print data acquisition unit 100 of the image forming apparatus 1 acquires print data 300 from the terminal 2 through a port of the pull-printing server 210 of the terminal 2, the port being set by the port setting unit 230. Before acquisition of the print data 300, the pull-print data acquisition unit 100 can perform user authentication with reference to account setting 400.

The pull-printing server 210 of the terminal 2 stores and accumulates the print data 300 in the storage unit 29. The pull-printing server 210 functions as, for example, a spooler of the operating system (OS). The pull-printing server 210 also functions as a server that transmits the accumulated print data 300 in response to a request coming through a port used only for pull printing of the image forming apparatus 1.

The pull-printing server 210 sends a response to a search made by the search unit 220 with management information of a simple network management protocol (SNMP), XML data of web services description language (WSDL) or the like.

When the pull-printing server 210 receives a request from the image forming apparatus 1 via a dedicated TCP/IP port or UDP port, the pull-printing server 210 sends the print data 300 stored and accumulated in the storage unit 29 to the image forming apparatus 1.

The search unit 220 searches for the pull-printing server 210 and image forming apparatus 1 in order to set a control program. The search unit 220 sends, for example, a broadcast or the like to the network 5 and the terminal 2 through a loopback connection in order to initiate a search. During the search operation, the search unit 220 can select a control program, such as a device driver, compatible with the pull-printing server 210 that made the response with SNMP or WSDL and the image forming apparatus 1, and can set the selected control programs. The search unit 220 can be implemented as a part of the universal printer driver features.

The port setting unit 230 sets different ports for the pull-printing server 210 and image forming apparatus 1 that have been detected by the search unit 220. The port setting unit 230 sets, for example, a TCP/IP port or a UDP port exclusively used for pull printing of the image forming apparatus 1 on the detected pull-printing server 210. In addition, the port setting unit 230 sets, for example, a standard TCP/IP port or a line printer daemon (LPR) protocol port on the detected image forming apparatus 1.

The port setting unit 230 can be implemented as a part of the universal printer driver features. In addition, the port setting unit 230 can have a function of installing printer drivers of the pull-printing server 210 and image forming apparatus 1.

The print data 300 is document data including text data, image data, and other types of data. The print data 300 may be data that is output by a user from application software and is converted by the device driver into a page description language (PDL) format. The print data 300 may be document data output to be pull-printed. In addition, the print data 300 may be data acquired from an external recording medium. Furthermore, the print data 300 may be data once acquired from the image forming apparatus 1. In this case, the print data 300 may be data that is read by the document reading unit 12 of the image forming apparatus 1 and is subjected to image processing by the image processing unit 11.

The account setting 400 is prepared for every user account and contains authentication information, such as a user ID and a preset password, authorization information, address information, billing information, and some other types of information. The user ID includes a user's identification (ID), a user number, a user name, etc. The password includes a password, a signature, biometrics information, etc. to be input at the time of user authentication. The authorization information is information about the authorization of an administrator (authorized user), general users, guest users, etc. The address information includes an IP address of the user's terminal 2, installation information of the pull-printing server 210, dedicated port information, electric mail addresses, address books, telephone numbers, facsimile numbers, and document box addresses. The billing information is information used to charge for monochrome printing and color printing per page or by some other charge policy. The billing information can include information about charges at stores and information about network printing in addition to the page charge.

The control unit 10 of the image forming apparatus 1 functions as a pull-print data acquisition unit 100 by executing the control program stored in the storage unit 19.

The control unit 20 of the terminal 2 functions as the pull-printing server 210, search unit 220, and port setting unit 230 by executing the control program stored in the storage unit 29.

The respective units of the image forming apparatus 1 and the terminal 2 are hardware resources that implement the image forming method according to the present disclosure.

### [Pull Print Setting/Printing Processing by Image Forming System X]

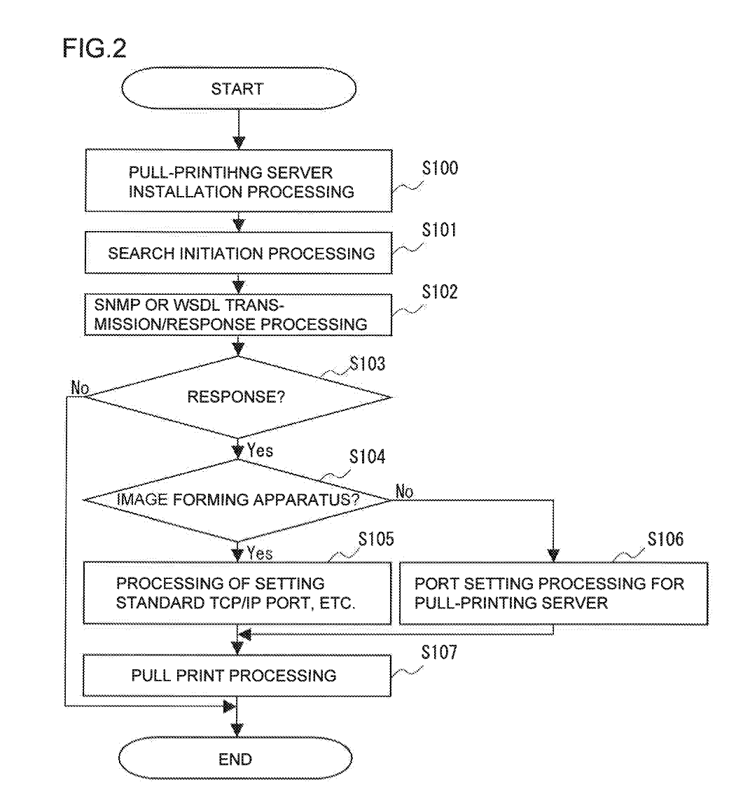

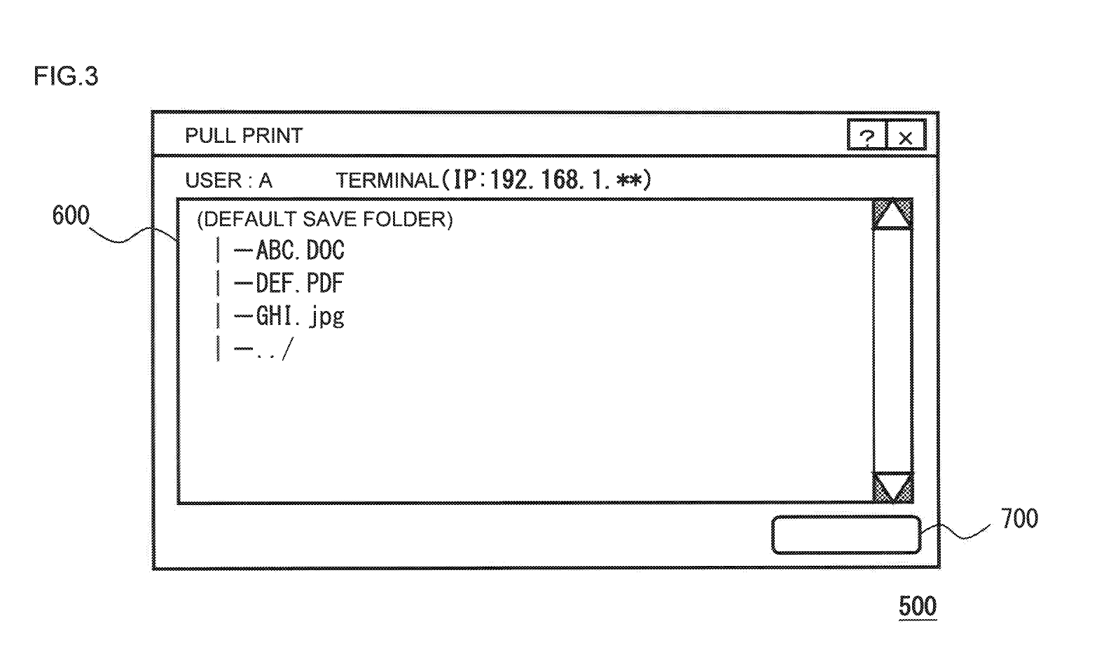

Referring to FIGS. 2 to 3, descriptions will be made about pull print setting/printing processing performed by the image forming system X according to the embodiment of the present disclosure.

In the pull print setting/printing processing of this embodiment, the terminal 2 searches for the image forming apparatus 1 and pull-printing server 210 when installing a universal printer driver or the like. The pull-printing server 210 responds to the search. Upon reception of the response, the terminal 2 automatically creates a port dedicated to the pull-printing server 210. Then, the image forming apparatus 1 performs pull printing by using the dedicated port.

The pull print setting/printing processing according to the embodiment is executed mainly by the control unit 20 of the terminal 2 that implements a program stored in the storage unit 29 in cooperation with the respective units as hardware resources.

Referring to the flow chart in FIG. 2, the details of the processing will be given step by step.

### (Step S100)

First, the control unit 20 functions as a port setting unit 230 to perform installation processing to install a pull-printing server 210.

The control unit 20 acquires a control program for implementing the pull-printing server 210 from a predetermined recording medium or a server (not shown) on the network 5 in response to an instruction input through an input unit 22 by a user, and installs the control program.

After installation of the control program for the pull-printing server 210, the control unit 20 runs the control program as a background service or a daemon.

### (Step S101)

Next, the control unit 20 functions as a search unit 220 to perform search initiation processing.

The control unit 20 sends, for example, a broadcast to the network 5 to install a universal printer driver or the like, and thereby searches for the image forming apparatus 1. To the search signal, the control unit 10 of the image forming apparatus 1 returns a response.

In addition, the terminal 2 receives the broadcast through the loopback connection or the like, and the pull-printing server 210 running as a background service or daemon also returns a response.

### (Step S102)

Next, the control unit 20 functions as the search unit 220 to perform SNMP or WSDL transmission/response processing.

The control unit 20 transmits SNMP information, information for WSDL response in accordance with a simple object access protocol (SOAP), or the like to the image forming apparatus 1 and pull-printing server 210 that have responded to the broadcast.

To respond to the information, the control unit 10 of the image forming apparatus 1 and the pull-printing server 210 send a response with SNMP management information, XML data of the WSDL, or the like.

The management information, XML data or the like may contain the model name, the version number of the pull-printing server 210, the type and directory name of the accumulated print data 300, the model type of the image forming apparatus 1 supporting the pull printing feature, and an ID, a password and other types of identification of a user who is authorized to perform pull printing.

### (Step S103)

Next, the control unit 20 functions as the search unit 220 to determine whether the image forming apparatus 1 and pull-printing server 210 have responded. When receiving a response from the image forming apparatus 1 capable of installing the universal printer driver or the like or the pull-printing server 210, the control unit 20 provides a Yes answer. The control unit 20 provides a No answer in other cases, that is, in the case where there is no corresponding response.

If Yes, the control unit 20 goes to step S104.

If No, the control unit 20 terminates the pull print setting/printing processing.

### (Step S104)

Next, the control unit 20 functions as the search unit 220 to determine whether the response has been transmitted from the image forming apparatus 1. In a case where the response has been transmitted from the image forming apparatus 1, the control unit 20 provides a Yes answer. The control unit 20 provides a No answer in the other cases, that is, in the case where the response has been transmitted from the pull-printing server 210.

If Yes, the control unit 20 goes to step S105.

If No, the control unit 20 goes to step S106.

### (Step S105)

In the case where the response has been transmitted from the image forming apparatus 1, the control unit 20 functions as the port setting unit 230 to perform setting processing of standard TCP/IP port or the like.

The control unit 20 sets a standard TCP/IP port, LPR port, or other types of port compatible with the detected image forming apparatus 1, and stores the setting in the storage unit 29. Alternatively, the control unit 20 can install a control program of the image forming apparatus 1 by using the universal printer driver.

Subsequently, the control unit 20 goes to step S107.

### (Step S106)

In a case where the response has been transmitted from the pull-printing server 210, the control unit 20 functions as the port setting unit 230 to perform setting processing of a port dedicated to the pull-printing server 210.

The control unit 20 sets a dedicated port compatible with the detected pull-printing server 210, and stores the setting in the storage unit 29. The control unit 20 can transmit the information about the dedicated port to the image forming apparatus 1. In this case, the control unit 10 of the image forming apparatus 1 functions as the pull-print data acquisition unit 100 to acquire the information about the dedicated port and the user ID or the other identification of the terminal 2 and input them in the account setting 400 in the storage unit 19.

Subsequently, the control unit 20 goes to step S107.

### (Step S107)

In step S107, the control unit 20 functions as the pull-printing server 210 to perform pull print processing.

If the pull-printing server 210 is installed after completion of setting of the universal printer driver, the control unit 20 performs pull print processing.

More specifically, if a user instructs setting the pull-printing server 210 as an output server, the control unit 20 stores and accumulates print data 300 in the storage unit 29.

FIG. 3 shows that when the user makes user authentication through the operation panel unit 16 of the image forming apparatus 1 and provides an instruction to invoke a pull printing function, the control unit 10 acquires the instruction. In this case, the control unit 10 refers to the account setting 400 to access the terminal 2 of the user through the preset dedicated port, and shows a pull print function screen as shown by an exemplary screen 500. If the user selects print data 300 displayed in a display field 600, the control unit 10 retrieves the print data 300 from the terminal 2, causes the image forming unit 17 to form an image on a sheet of recording paper, and outputs it. In addition to image formation, the control unit 10 can transmit the print data 300 through facsimile transmission and can store it in a document box. With depression of a button 700, the control unit 10 terminates the pull printing function.

Through the above-described steps, the pull print setting/printing processing according to the embodiment of the disclosure is completed.

The above-described configurations can provide the following effectiveness.

Conventional setting of the pull-printing server 210 in a terminal, especially the terminal 2, requires users to select a target model using a universal printer driver and then manually set a port dedicated to the model.

However, in the image forming system X according to the embodiment of the disclosure including the image forming apparatus 1 enabling pull printing and the terminal 2, the terminal 2 includes the pull-printing server 210 that accumulates print data 300 for pull printing, the search unit 220 that searches for the pull-printing server 210 and the image forming apparatus 1, and the port setting unit 230 that sets different ports for the pull-printing server 210 and image forming apparatus 1 that have been detected by the search unit, while the image forming apparatus 1 includes the pull-print data acquisition unit 100 that acquires print data 300 from the terminal 2 through the port of the pull-printing server 210 set by the port setting unit 230 of the terminal 2.

According to the configuration, a port dedicated for the image forming apparatus 1 and a port dedicated for the pull-printing server 210 can be automatically set with the universal printer driver or the like. The automatic setting makes it easier to set the pull-printing server 210, thereby saving a user's time and effort. This also can reduce printer management costs.

In addition, the image forming apparatus 1 according to the embodiment of the disclosure is characterized in that the search unit 220 transmits data of SNMP or WSDL protocol to search for the pull-printing server 210 and image forming apparatus 1.

This configuration makes it possible to acquire data necessary to set using SNMP or WSDL, thereby facilitating setting of dedicated ports, protocols and so on. Even if a new model of the image forming apparatus is developed, the universal printer driver can easily support the new model, thereby cutting development costs.

In the embodiment of the present enclosure, the pull-printing server 210 is installed and set in the terminal 2; however, this is just an example. The pull-printing server 210 can be implemented by a physical server apparatus. Alternatively, the image forming apparatus 1 can be provided with a pull-printing server feature.

According to the configuration, the pull-printing server 210 of the terminal 2, the other physical server apparatus, and the pull-printing server 210 set in the image forming apparatus 1 can be set at once. In addition, the image forming apparatus 1 can switch over these pull-printing servers 210 before performing a print operation.

The present disclosure can be applied to information processing apparatuses in addition to the image forming apparatuses. That is, the present disclosure can be configured to have a network scanner, a server additionally connected to a scanner via a USB, or the like.

The above configuration and operation are merely examples and may be appropriately modified for implementation without departing from the scope of the present disclosure.

What is claimed is:

1. An image forming system comprising an image forming apparatus enabling pull printing and a terminal, wherein
the terminal includes:
a pull-printing server that accumulates print data for pull printing;
a search unit that searches for the pull-printing server and the image forming apparatus; and
a port setting unit that sets different ports for the pull-printing server and the image forming apparatus that have been detected by the search unit, and
the image forming apparatus includes:
a pull-print data acquisition unit that acquires the print data from the terminal through the port of the pull-printing server set by the port setting unit of the terminal.

2. The image forming system according to claim 1, wherein
the search unit of the terminal makes a search by sending a response between the search unit and the pull-printing server and image forming apparatus in accordance with SNMP and WSDL.

3. An image forming method performed by an image forming system including an image forming apparatus enabling pull printing and a terminal, the method comprising the steps of:
searching for a pull-printing server and the image forming apparatus;
setting different ports for the detected pull-printing server and the image forming apparatus;
accumulating print data for pull printing in the pull-printing server; and
acquiring the print data from the terminal through the port set for the pull-printing server.

4. A control program executed by a terminal of an image forming system, the system including an image forming apparatus enabling pull printing and the terminal, the program causing the terminal to:
search for a pull-printing server and the image forming apparatus;
set different ports for the detected pull-printing server and the image forming apparatus; and
accumulate print data for pull printing in the pull-printing server.
